(19) United States
(12) Patent Application Publication
(10) Pub. No.: US 2009/0158793 A1
(43) Pub. Date: Jun. 25, 2009

(54) KEY MECHANISM FOR ELECTRONIC DEVICE

(75) Inventors: YE LIU, Shenzhen City (CN); HSIAO-HUA TU, Shindian (TW); ZHONG-SHU QIN, Shenzhen City (CN); GANG YANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/187,459

(22) Filed: Aug. 7, 2008

(30) Foreign Application Priority Data
Dec. 21, 2007 (CN) 200710203330.0

(51) Int. Cl. E05B 19/04

(52) U.S. Cl. 70/408

(57) ABSTRACT

An electronic device (100) includes a housing (11) defining a mounting hole (1111), a key mechanism (10) mounted to the housing and partially exposed by the mounting hole, and a printed circuit board (20) received in the housing and corresponding to the key mechanism. The key mechanism includes a key body (13). The key body has a band (133) surrounding an edge thereof and is sealingly connected to the housing.

### BACKGROUND

1. Field of the Invention

The present invention generally relates to key mechanisms, specifically to key mechanisms for electronic devices, such as mobile phones.

2. Description of Related Art

With the development of wireless communication and information processing technologies, electronic devices, such as mobile telephones and electronic notebooks, are now in widespread use. These electronic devices enable consumers to enjoy high technology services, almost anytime and anywhere. A key mechanism as input mechanism is indispensable in many electronic devices.

A typical key mechanism for an electronic device includes an upper shell and a keypad. The upper shell defines a plurality of holes therethrough. The keypad is formed with a plurality of keys on a top surface thereof. The keypad is mounted under the upper shell and each key is exposed through a corresponding hole of the upper shell. However, dust and vapor may enter the electronic device through a gap between the upper shell and the keypad and damage inner circuitry of the electronic device.

Therefore, there is room for improvement.

### BRIEF DESCRIPTION OF THE DRAWINGS

Many aspects of the present key mechanism can be better understood with reference to the following drawings. The components in the drawings are not necessarily drawn to scale, the emphasis instead being placed upon clearly illustrating the principles of the present key mechanism. Moreover, in the drawings, like reference numerals designate corresponding parts throughout the several views.

FIG. 1 is an explored, isometric view of a key mechanism used with an electronic device, in accordance with an exemplary embodiment.

FIG. 2 is similar to FIG. 1, but viewed from another angle.

FIG. 3 is an enlarged, partially cut-away view of the key body of the key mechanism shown in FIG. 1.

FIG. 4 is an assembled, isometric view of the electronic device with the key mechanism shown in FIG. 1.

FIG. 5 is a partially cross-sectional view of the electronic device along line V-V of FIG. 4.

### DETAILED DESCRIPTION OF THE EMBODIMENTS

The present key mechanism is suitable for electronic devices, such as mobile phones, personal digital assistants (PDAs), and the like. Other applications with a similar use for the key mechanism employed can also be found.

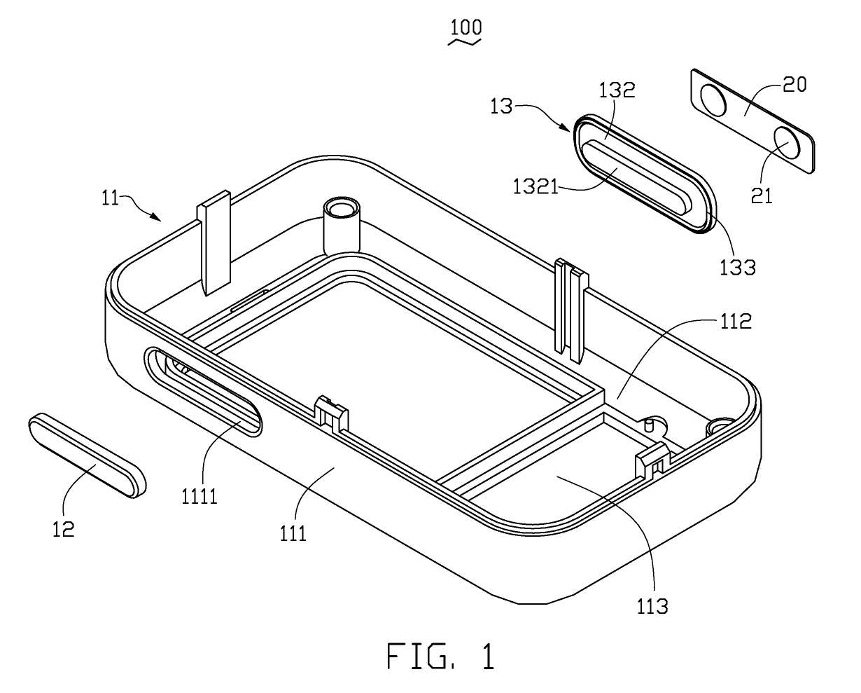

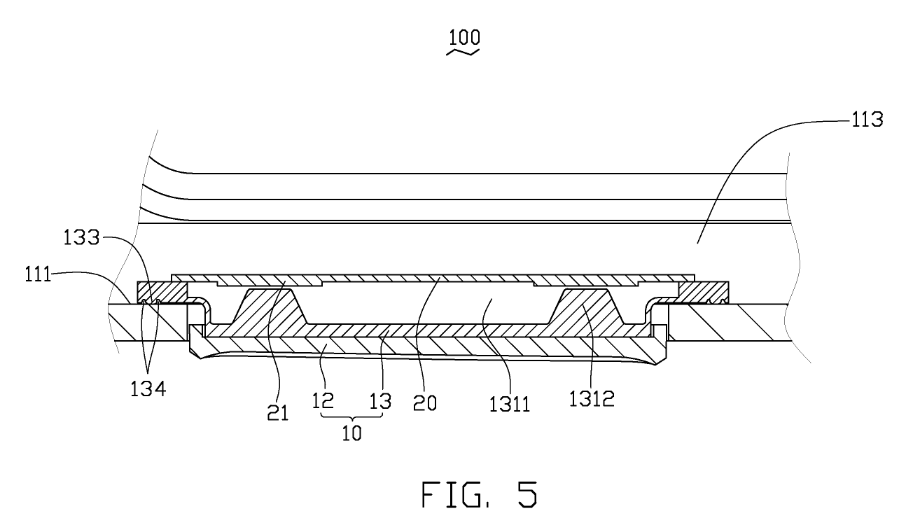

Referring to FIGS. 1 and 5, an electronic device 100 includes a housing 11, a key mechanism 10 mounted to the housing 11, and a printed circuit board (PCB) 20 received in the housing 11 and corresponding to the key mechanism 10.

The housing 11 has a substantially rectangular main surface 112 and a sidewall 111 extending from the main surface 12. The main surface 112 and the sidewall 111 define a chamber 113. The sidewall 111 also defines a substantially rectangular mounting hole 111 that communicates with the chamber 113.

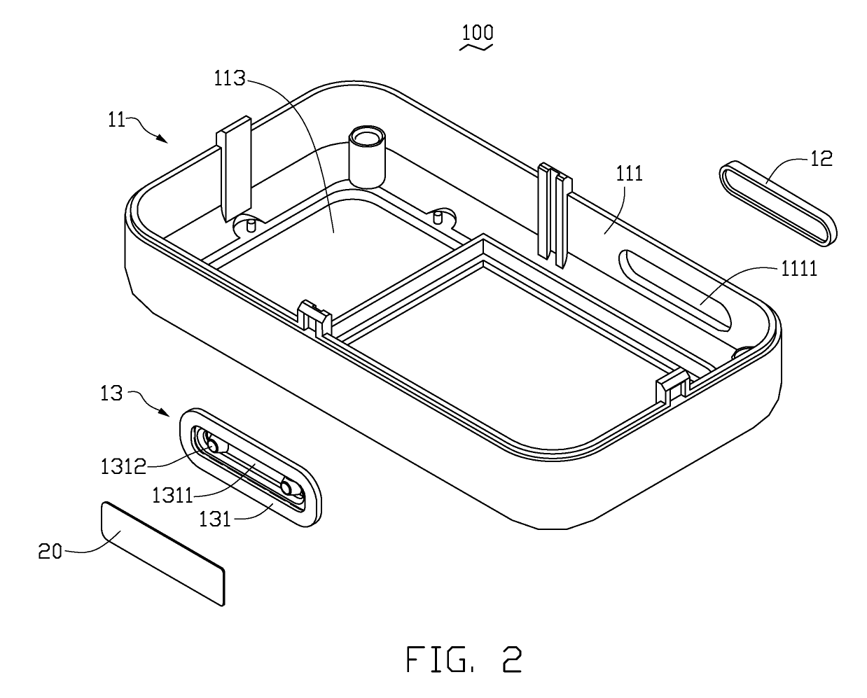

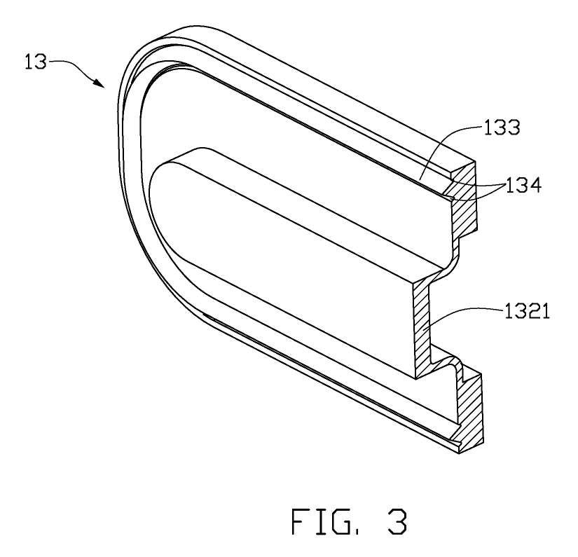

Referring to FIGS. 2-3, the key mechanism 10 includes a substantially rectangular key body 13 and a substantially rectangular key cap 12 mounted to the key body 13. The key body 13 has a first side 131 and an opposite second side 132. A center portion of the first side 131 of the key body 13 defines a recess 1311 that corresponds to a protrusion 1321 of the second side 132 of the key body 13. The key cap 12 is adhered on the second side 132 of the key body 13 for covering the protrusion 1321. Any number of contacting points 1312 are formed on a bottom surface of the recess 1311. A band 133 is formed at the second side 132, surrounding an edge of the key body 13. A cross section of the band 133 can be triangular or rectangular. The key body 13 defines an annular groove 134 on each side of the band 133.

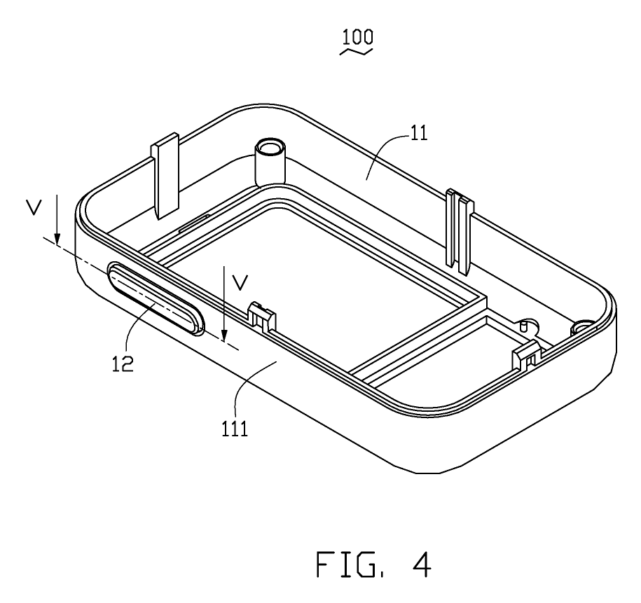

The key body 13 is made of elastic material. The band 133 is made of weldable material. The band 133 and the key body 13 can be made by dual material dual injection molding. The key body 13 is mounted in the chamber 113 of the housing 11 by welding the band 133 to the sidewall 111, and the key cap 12 adhered to the key body 13 is exposed by the mounting hole 1111 of the housing 11, as represented in FIG. 4. The band 133 is sealed with the housing 11, thereby preventing dust and/or vapor from entering the electronic device through the key mechanism 10.

The PCB 20 is substantially rectangular and has two switchpoints 21. Each switchpoint 21 corresponds to a contacting point 1312 so when the contacting point 1312 is pressedtowards PCB 20, the switchpoint 21 is activated, thereby sending a control signal to the electronic device.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A key mechanism for an electronic device, the electronic device including a housing, the key mechanism comprising a key body, the key body including:
at least one contacting point formed on a first side of the key body;
a protrusion formed on a second side of the key body; and
a band formed on the second side of, and surrounding, an edge of the key body, and the band connected to the housing of the electronic device.

2. The key mechanism of claim 1, wherein the band is sealed with the housing.

3. The key mechanism of claim 1, wherein a cross section of the band is triangular or rectangular.

4. The key mechanism of claim 1, wherein the band is made of a weldable material.

5. The key mechanism of claim 1, wherein the key body has a recessed center on one side that forms a protrusion on the second side, and the at least contacting point is within the recess.

6. The key mechanism of claim 1, further comprising a key cap associated with the key body and for covering the protrusion.

7. The key mechanism of claim 1, wherein the key body defines an annular groove adjacent to the band.

8. An electronic device comprising;
a housing defining a mounting hole,
a key mechanism mounted to the housing and partially exposed by the mounting hole, the key mechanism comprising a key body, the key body including a band surrounding an edge thereof and being connected to the housing; and
a printed circuit board associated with the housing and corresponding to the key body.

9. The electronic device of claim 8, wherein the band is sealed with the housing.

10. The electronic device of claim 8, wherein a cross section of the band is triangular or rectangular.

11. The electronic device of claim 8, wherein the key body has a recessed center on one side that forms a protrusion on the second side, and the at least contacting point is within the recess.

12. The electronic device of claim 8, wherein the key body defines an annular groove adjacent to the band.

13. A key mechanism comprising
a key body, the key body having a first side and a second side, a recess in a center portion of the first side forming a protrusion in a center portion of the second side;
at least one contacting point formed at a bottom of the recess; and
a band formed on the second side and surrounding an edge of the key body.

14. The key mechanism of claim 13, wherein a cross section of the band is triangular or rectangular.

15. The key mechanism of claim 13, wherein the band is made of a weldable material.

16. The key mechanism of claim 13, further comprising a key cap associated with the key body for covering the protrusion.

17. The key mechanism of claim 13, wherein the key body defines an annular groove adjacent to the band.
